(19) United States
(12) Patent Application Publication
(10) Pub. No.: US 2010/0045700 A1
(43) Pub. Date: Feb. 25, 2010

(54) DEVICE FOR WATCHING REAL-TIME AUGMENTED REALITY AND METHOD FOR IMPLEMENTING SAID DEVICE

(75) Inventors: Valentin Lefevre, Puteaux (FR); Nicolas Livet, Paris (FR); Alan Savary, Charenton Le Pont (FR)

Correspondence Address: BROWDY AND NEIMARK, P.L.L.C.;624 NINTH STREET, NW, SUITE 300, WASHINGTON, DC, 20001-5303, US

(73) Assignee: TOTAL IMMERSION, Suresnes (FR)

(21) Appl. No.: 12/522,948

(22) PCT Filed: Jan. 10, 2008
(86) PCT No.: PCT/FR08/00030

§ 371 Date: Jul. 15, 2009

(30) Foreign Application Priority Data
Jan. 12, 2007 (FR) 0752641

(51) Int. Cl. G09G 5/00

(52) U.S. Cl. 345/633

(57) ABSTRACT

The invention relates to a real-time augmented-reality watching device (300), which comprises an image sensor (335) such as a PTZ camera, a visualisation system (320) and a control interface (310). In this device, the camera is controlled by a control interface operated by the user. Once the user has received (610) orientation information on the desired line of sight from the control interface, the orientation information on the line of sight is transmitted to the camera (615), the camera being powered and capable of movement. Then the camera transmits the orientation of its line of sight (620). The camera transmits a video stream in parallel. The position at which must be inserted data, such as the representation of a virtual three-dimensional object, is determined from the data resulting from the calibration and the orientation of the line of sight of the camera received from the latter (640). The data is further inserted in real time into the video stream that is transmitted to the visualisation system (645). A calibration of the camera is preferably carried out during the device set up (600) in order to improve the device performance.

The present invention concerns observation devices such as telescopes and more particularly augmented reality observation devices enabling addition in real time of virtual objects to the observed image and the methods of using such devices.

A large number of busy sites such as tourist sites are equipped with telescopes or binoculars enabling their users to observe a panorama with a magnification factor, variable or not, providing the possibility of better appreciating the view.

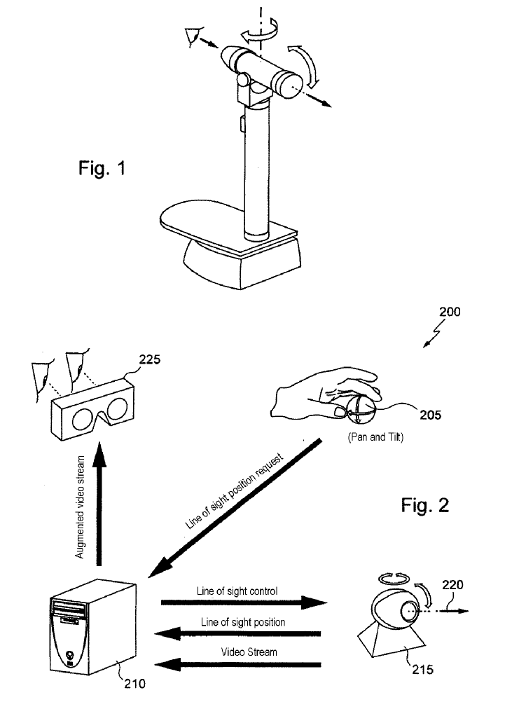

Here a telescope means a device installed on many tourist sites offering an interesting view to the observer. The principle of operation of the telescope is as follows: the user inserts a coin in the device and then has a predetermined time to observe the view on offer. Observation is similar to what would be done using a pair of binoculars. The principal function thus consists in providing via a dedicated optical system a “magnified view” of the panorama observed. The latter offers a restricted field of vision around the line of sight. The limitation of the field of vision of the optical system is compensated by the two degrees of freedom offered by the device through rotation of the line of sight in the horizontal plane, that is to say around the principal axis of the device, and by rotation of the line of sight in the vertical plane, that is to say around an axis perpendicular to the principal axis of the device. Thanks to these movements, the user is in a position to scan a large part of the observable panorama and thus to observe in detail, with the aid of the magnification, the areas of interest. FIG. 1 shows an example of such a telescope.

However, the user of the system has no other information than what is naturally present in the image. Now, to provide added value at a site, it is often important to provide complementary information. This information can be cultural or technical, for example, but also advertising or economic to indicate, for example, the presence of restaurants or hotels.

So-called “augmented reality” techniques are adapted to add such information to enrich the observed image. They enable to appear in the same image the actual view and the additional information. That information can then take the form of symbols such as arrows, logos, a particular explanation, text and also three-dimensional virtual objects, animated or not. It is thus possible, for example, to make an old building that has now disappeared spring up on top of the ruin that the user would have had to make do with if they had only a standard telescope.

Augmented reality vision devices exist. For example, the company YDreams proposes a solution called Virtual Sightseeing (Registered Trade Mark). This device has one degree of freedom. A drawback of this device is that the quality of service drifts over time. Spatial and temporal synchronization depend not only on the accuracy of the encoders used to determine movement but also on the accuracy and the stability of the mechanical connections employed. In this respect it should be noted that an error of one degree in the horizontal plane represents an error of more than four meters in the X coordinate of an object situated two hundred and fifty meters from the observation point. Any mechanical connection of this kind consisting in a movement of heavy parts, however accurate it might be, evolves over time. This affects the accuracy of the synchronization between the virtual and the real that deteriorates over time. Another device, offered by the company Trivisio Prototyping, has two degrees of freedom, like standard telescopes. However, this device has the same drawback of the quality of service drifting over time.

The invention solves at least one of the problems explained above.

Thus the object of the invention is a method for a real time augmented reality observation device comprising an image sensor, a viewing system and a command interface, this method being characterized in that it comprises the following steps:
receiving a request including line of sight orientation information transmitted by said command interface;
transmitting said line of sight orientation information to said image sensor, said image sensor being mobile and motorized;
receiving from said image sensor the orientation of its line of sight;
receiving at least one image from said image sensor;
determining in said received image the position at which at least one item of data must be inserted, according to the orientation of the line of sight of said image sensor; and
inserting said at least one data item in real time into said received image at the position so determined.

The method of the invention distinguishes user control commands from commands from the image sensor and thus improves the accuracy and the reliability of the observation device, with little drift over time. The device is thus more robust over and in the face of external aggression. The camera provides the real view of an area of the panorama, to which a computer adds information elements accurately superposed on the various elements of the image. This method improves the quality of spatial and temporal synchronization between the real and the virtual as it now depends only on parameters inherent to the image sensor. The method of the invention furthermore offers possibilities of correcting disturbances. Moreover, the method of the invention allows great freedom as to the form that the command interface can take.

The method of the invention advantageously includes a phase of calibration of said image sensor to take into account any imperfections of the latter.

In one particular embodiment, said calibration step comprises the calibration of at least one of the parameters included in the set of parameters comprising correcting radial distortion of said image sensor, correcting roll of said image sensor, correcting the pan and tilt of the line of sight of said image sensor and the offset between the optical center and the rotation center of said image sensor.

Still in one particular embodiment, said image sensor comprises a zoom function and the calibration of said at least one parameter is effected for a plurality of zoom factors.

The calibration of the image sensor and in particular the calibration of the image sensor for a number of zoom factors means that the defects of the camera can be treated as extrinsic parameters of the camera and the necessary calculations to process the images from that image sensor optimized.

Still in one particular embodiment, the method further comprises a step of colocation of said image sensor and the scene observed by said image sensor to determine the pose of said at least one data item to be inserted into said image received in said observed scene.

Said at least one data item to be inserted in said received image is advantageously a representation of a three-dimensional model, animated or not.

In one particular embodiment, said orientation of the line of sight is defined with two degrees of freedom and said image sensor comprises a zoom function to enable the user to observe the point they wish to view, with the required magnification.

Another object of the invention is a computer program including instructions adapted to execute each of the steps of the method described above.

A further object of the invention is information storage means, removable or not, partially or totally readable by a computer or a microprocessor containing code instructions of a computer program for executing each of the steps of the method described above.

A further object of the invention is a real time augmented reality observation device comprising an image sensor, a viewing system and a command interface, this device being characterized in that it comprises the following means:
means for receiving line of sight orientation information transmitted by said command interface;
means for controlling the orientation of the line of sight of said image sensor according to said orientation information received, said image sensor being mobile and motorized;
means for receiving the orientation of the line of sight of said image sensor;
means for receiving at least one image from said image sensor;
means for determining in said received image the position at which at least one item of data must be inserted, according to the orientation of the line of sight of said image sensor; and
means for inserting in real time into said received image said at least one data item at the position so determined.

The device of the invention separates user control commands from commands from the image sensor and thus improve the accuracy and the reliability of the observation device, with little drift over time. The device is thus more robust over and in the face of external aggression. The camera provides the real view of an area of the panorama, to which a computer adds information elements accurately superposed on the various elements of the image. This device improves the quality of spatial and temporal synchronization between the real and the virtual as it now depends only on parameters inherent to the image sensor. The device of the invention furthermore offers possibilities of correcting disturbances. Moreover, the device of the invention allows great freedom as to the form that the command interface can take.

The device of the invention advantageously includes means for transmitting said received image including said at least one data item to enable the user to view on an appropriate device the augmented images coming from said image sensor.

In one particular embodiment, said image sensor and/or said storage means is/are remotely sited from said observation device. This embodiment gives the user of the observation device the benefit of a viewpoint that they cannot reach and protects the image sensor and/or the storage means against external aggression such as vandalism.

Other advantages, objects and features of the present invention emerge from the following detailed description, given by way of nonlimiting example, with reference to the appended drawings in which:

FIG. 1 represents diagrammatically a standard telescope as used at tourist locations;

FIG. 2 illustrates diagrammatically the observation device of the invention;

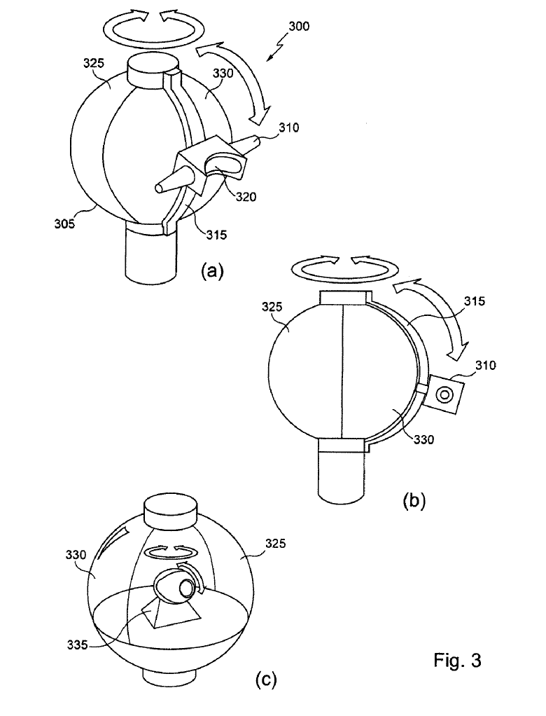

FIG. 3, comprising FIGS. 3a, 3b and 3c, shows one example of a part of the observation device of the invention including a sphere accommodating a motorized camera on which are mounted a command interface and a viewing system;

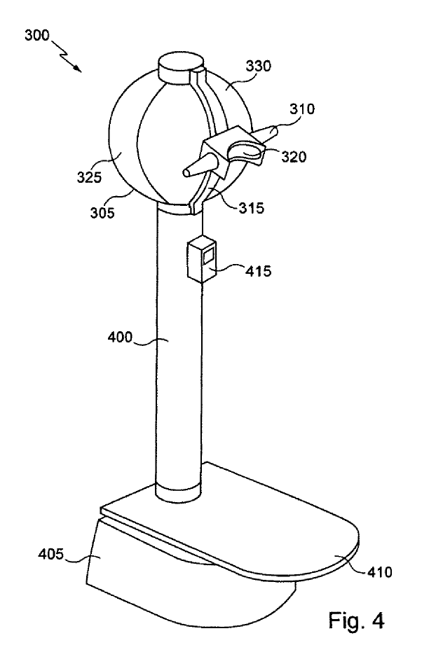

FIG. 4 illustrates in its entirety the observation device shown in FIG. 3;

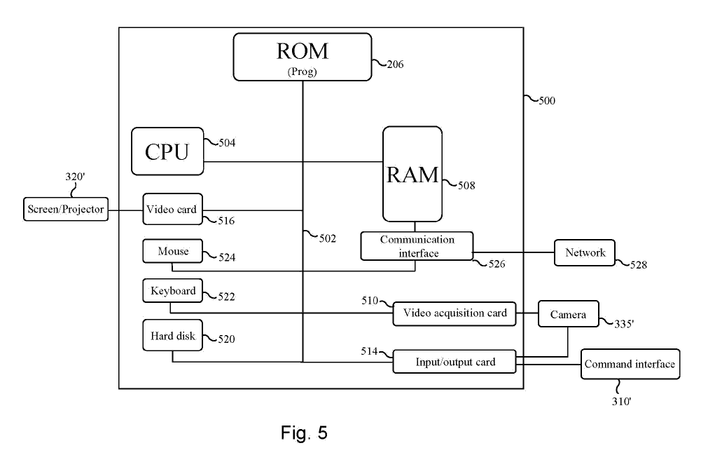

FIG. 5 illustrates one example of a device that can be used to control movement of the camera and to insert virtual objects in images coming from the camera;

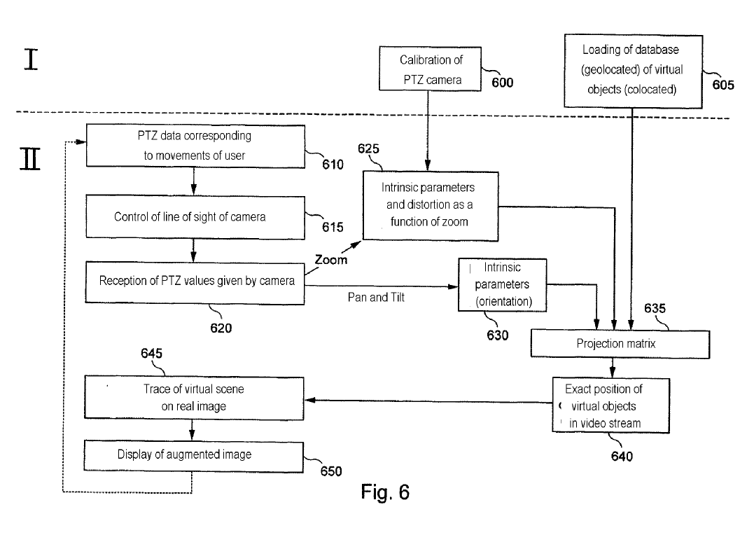

FIG. 6 represents diagrammatically certain steps in the operation of the observation device of the invention; and

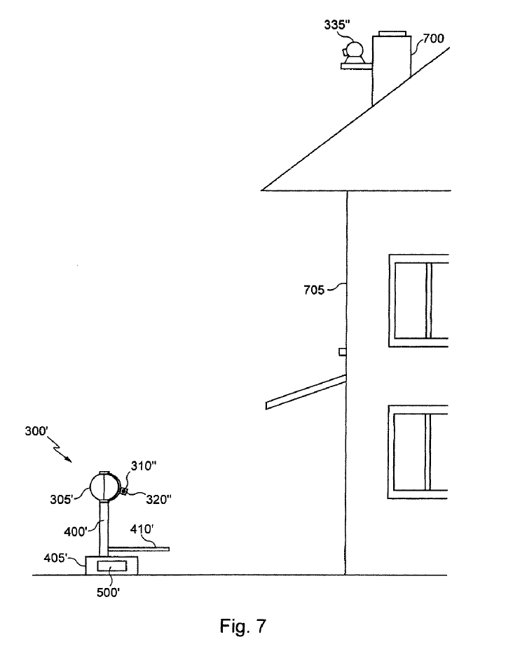

FIG. 7 shows another example of an observation device of the invention in which the motorized camera is remotely sited.

According to the invention, the image capture device is controlled indirectly, that is to say the movement of the camera is not physically or materially coupled to the movement effected by the user. The aiming command interface is separate from the positioning interface of the imaging module, such as a camera. The two interfaces are coupled by software, which further offers possibilities of correcting disturbances. Thus movements of the user are communicated to the imaging module via the software interface. The virtual scene being colocated with the camera and not with the hardware physically manipulated by the user, any loss of accuracy of the movement sensors of the command interface has no impact on the quality of integration of virtual elements into the real image. The imaging module, which is motorized, is preferably capable of producing lateral movements (pan) and elevation movements (tilt). This type of imaging module may be referred to as a PT (pan, tilt) camera. The imaging module can advantageously also perform zooming, and this type of imaging module may be called a PTZ (pan, tilt, zoom) camera.

The device of the invention includes a video acquisition system producing a video stream made up of images corresponding to the real view observed, an image processing system for augmenting the video stream with virtual elements embedded in real time as a function of the direction of the line of sight of the device, and a system for viewing the augmented video stream. The line of sight is determined in real time by movement sensors. It is essential for the position of the line of sight of the camera to be known accurately for correct operation of the system, in order to insert the virtual objects at the appropriate locations, that is to say to synchronize spatially the real and virtual environments.

Separating the command function for defining the position of the line of sight as required by the user, that is to say the user interface, from the means for obtaining that position, that is to say the internal mechanism for controlling the movements of the camera, entails the provision of a command interface for not only defining but also continuously transmitting the requested position of the line of sight. The use of a motorized camera means that its line of sight can be moved as required.

This interface is preferably provided by the computer used to insert the virtual objects into the images coming from the camera. This computer receives the line of sight orientation request from the command interface, transmits instructions to the motorized camera to modify the line of sight, and receives from the camera the exact position of the line of sight. This is referred to as indirect control of the line of sight. The camera line of sight orientation information is received from the camera in the form of a data stream, for example. Such a data stream can transmit 15 items of orientation and zoom data per second, for example.

When the position of the line of sight is known, the video stream is augmented and reproduced.

The use of the position of the line of sight provided by the motorized camera and not by the command interface improves the quality of spatial and temporal synchronization between the real and the virtual, which then depends only on parameters inherent to the camera.

One object of indirect control is to limit the propagation of errors within the system. Thus the durability of synchronization between the virtual and the real over time relies entirely on the quality and the reliability of the data received from the motorized camera. Even if the accuracy of the command interface deteriorates over time, it will remain of limited impact: the line of sight will perhaps not correspond exactly to what was requested via the interface but the real and the virtual will continue to be perfectly synchronized.

Moreover, separating the command interface from the rest of the system provides great freedom as to the form that the interface can take. For example, it can be a keyboard, a joystick or a dedicated pointing system such as a mechanical system with movement sensing. A pointing system of this kind can mechanically couple the command interface and the viewing system.

FIG. 2 illustrates diagrammatically the device 200 of the invention. As shown, the device 200 includes a command interface 205 that transmits to the computer 210 a line of sight position request. In turn the computer 210 transmits a command, corresponding to the line of sight position request, to the motorized camera 215, which has a line of sight 220. In parallel with this, the camera 215 transmits to the computer 210 the orientation of its line of sight, for example in data stream form, thus enabling processing of the images coming from the camera during the period of movement. The camera 215 also transmits a stream of images, preferably a continuous stream, to the computer 210, which integrates into the images from this video stream the virtual objects as required by the user, predefined scenarios and/or the context for forming the augmented video stream, which is transmitted to a viewing system 225.

The quality of the system depends on the characteristics of the motorized camera, which must be fast enough to respond to commands coming from the command interface, sufficiently accurate to reach the requested positions optimally, and sufficiently durable to maintain the quality of the above characteristics over time.

The architecture shown concentrates the problem of synchronizing the real and virtual environments at the camera, preferably a PT camera or a PTZ camera. A portion of the coordinates of its line of sight is determined when installing the observation system while another portion of the coordinates of its line of sight is determined in real time. The coordinates X, Y and Z as well as the roll about the line of sight are determined or calculated when installing the observation system, while the pan and tilt are supplied in real time. Similarly, if the zoom function on the line of sight is implemented, the zoom factor is determined in real time. To simplify the calculations, the frame of reference of the camera can be used as the reference frame of reference. As a result the X, Y and Z coordinates and the roll have zero values.

For reasons of robustness, the PTZ camera is preferably not accessible to the user. It is therefore necessary to integrate it into an appropriate receptacle. This receptacle must advantageously protect the camera from external aggression, intentional or otherwise, such as misuse, vandalism and inclement weather. This receptacle includes for example a two-way mirror part concealing the camera from the user but allowing it to film the panorama without distortion or loss of light.

To avoid distortion problems linked to the shape of the receptacle, the camera is placed here at the center of a sphere. Thus regardless of the position of the line of sight, the lens of the camera is always at the same distance from the receptacle.

To conform to the practical aspect of the observation device, the point of rotation of the line of sight of the camera is preferably situated at eye height. Alternatively, the camera can be remotely located, in particular to provide a view that the user could not otherwise have.

In one particular embodiment, the command interface, or PTZ interface, and the viewing system are on the sphere used as the camera receptacle. The shape of the sphere is then used as a guide for the PTZ interface and for the display system, the guide possibly taking the look of a mobile rail in meridian form.

FIG. 3, comprising FIGS. 3a, 3b and 3c, illustrates an example of a part of the observation device 300 including a sphere accommodating a PT camera or a PTZ camera, on which are mounted a command interface and a viewing system. FIG. 3a represents a part of the device as seen from the user side, FIG. 3b represents a part of the device as seen in profile, and FIG. 3c represents a part of the device as seen from the camera side. The illustrated part of the device comprises a sphere 305, a command interface 310 mounted on a guide 315, and a viewing system 320, here a binocular display. The sphere 305 preferably has two separate parts, a first part 325 that is transparent, semi-transparent or a one-way mirror, situated on the camera side, and a preferably opaque second part 330 situated on the user side. The command interface 310 advantageously comprises two handles enabling the user to move the command interface 310 over the opaque portion 330 of the sphere 305. To this end, the command interface 310 can move along the guide 315, the guide 315 being able to pivot approximately 180° about the vertical axis of the sphere 305. It is of course possible to restrict or to extend the movement of the command interface 310, in particular about the vertical axis of the sphere 305.

A motorized camera 335 is situated at the center of the sphere 305 as shown in FIG. 3c. The movement of the camera 335 is controlled by the movement of the interface 310. A movement along the vertical axis of the sphere of the command interface 310 causes a movement along the vertical axis of the camera 335 while a movement along the guide 315 of the command interface 310 causes a movement along an axis of the horizontal plane of the camera 335.

The movement of the command interface 310 is detected by an optical encoder the accuracy of which corresponds to that of the control movement of the camera 335, or by a set of sensors. For example, a linear position sensor can be integrated into the command interface 310 to determine its position on the guide 315 while an angular sensor is placed on the connection between the guide 315 and the sphere 305.

The computer used to control the movements of the camera 335 and to insert the virtual objects into the images coming from the camera 335 before they are transmitted to the viewing system 320 can be placed in the base (not shown) of the observation device 300.

FIG. 4 shows the observation device 300 shown in FIG. 3. Here the observation device comprises a stand 400 mounted on a base 405, a step 410 and a coin receptacle 415. It should be noted that the coin receptacle 415 is not necessary for implementing the invention.

By way of illustration, the camera 335 can be a camera equipped with a CCD (charge-coupled device) sensor having a resolution of HD 1080i, that is to say a resolution of 1080 lines with progressive scanning, with a refresh rate of 60 images per second, and a YUV-HD/HD-SDI type interface and an RS-232 port for controlling the movements of the camera and receiving data linked to its position. The binocular display 320 can comprise two OLED (organic light-emitting diode) displays, one for each eye, each having a resolution of 800×600 pixels (picture elements), a resolution of 24 bits, a refresh rate of 60 images per second, a brightness in excess of 50 cd/m², a contrast in excess of 200:1 and a VGA (Video Graphics Array) and USB (Universal Serial Bus) type interface.

FIG. 5 illustrates one example of a device that can be used to control the movements of the camera and to insert virtual objects into the images coming from the camera. The device 500 is a microcomputer or a workstation, for example.

The device 500 preferably includes a communication bus 502 to which are connected:
a central processor unit (CPU) or microprocessor 504;
a read-only memory (ROM) 506 that can contain the operating system and programs (Prog);
a random-access memory (RAM) or cache memory 508 including registers adapted to store variables and parameters created and modified during execution of the aforementioned programs;
a video acquisition card 510 connected to a camera 335′;
an input/output card 514 connected to the camera 335′ and to a command interface 310′; and
a graphics card 516 connected to a screen or projector 320′.

The device 500 can optionally further include:
a hard disk 520 that can hold the aforementioned programs (Prog) and data processed or to be processed in accordance with the invention;
a keyboard 522 and a mouse 524 or any other pointer device such as a light pen, a touch-sensitive screen or a remote control enabling the user to interact with the programs of the invention, in particular during the installation and/or initialization phases;
a communication interface 526 connected to a distributed communication network 528, for example the Internet, the interface being able to transmit and receive data; and
a memory card reader (not shown) adapted to read or write in the data card processed or to be processed in accordance with the invention. In particular, in one particular embodiment, the user can insert a memory card to store therein images coming from the camera 335, real or augmented.

The communication bus provides communication and interworking between the various elements included in or connected to the device 500. The representation of the bus is not limiting on the invention, and in particular the central processor unit can communicate instructions to any element of the device 500 either directly or via another element of the device 500.

The executable code of each program enabling the programmable device to implement the methods of the invention can be stored on the hard disk 520 or in the read-only memory 506, for example.

Alternatively, the executable code of the programs could be received via the communication network 528, via the interface 526, to be stored in exactly the same way as described above.

More generally, the program(s) can be loaded into one of the storage means of the device 500 before being executed.

The central processor unit 504 controls and directs execution of the instructions or software code portions of the program or programs of the invention, which instructions are stored on the hard disk 520 or in the read-only memory 506 or in the other storage elements referred to above. On power up, the program or programs stored in a non-volatile memory, for example on the hard disk 520 or in the read-only memory 506, are transferred into the random-access memory 508, which then contains the executable code of the program or programs of the invention, and registers for storing variables and parameters necessary to implement the invention.

It should be noted that the communication device including the device of the invention can also be a programmed device. The device then contains the code of the computer program or programs, for example in an application-specific integrated circuit (ASIC).

The device 500 includes an augmented reality application such as the D'Fusion software from Total Immersion (D'Fusion is a trade mark of Total Immersion). The principle of real time insertion of a virtual object into an image coming from a camera or other video acquisition means using that software is described in patent application WO 2004/012445.

FIG. 6 shows diagrammatically some steps of the operation of the observation device of the invention. The operation of the observation device includes an installation and initialization phase (phase I) and a utilization phase (phase II).

The installation and initialization phase includes a step of calibrating the PTZ camera (step 600) and a step of loading data used to enrich the real images (step 605). This data can be loaded when installing the observation device, when starting up the device or at regular or programmed times.

During the utilization phase, information relating to the movements of the line of sight of the user are received from the command interface (step 610) and used to control the line of sight of the camera (step 615). The camera then transmits the position of its line of sight and the zoom factor if the zoom function is implemented (step 620). The zoom factor is then used to retrieve the intrinsic parameters of the camera and the distortion parameters (step 625) by comparison with the values established during calibration of the camera during the initialization phase. In parallel with this, the pan and tilt data for the line of sight of the camera is used to retrieve data extrinsic to the camera as a function of the current level of zoom (step 630). A projection matrix is then determined from data coming from the steps 605, 625 and 630 (step 635). This projection matrix is used to determine the position of the elements, such as the virtual objects, to be inserted into the image from the camera (step 640). These elements, for example a representation of the virtual objects, are then inserted into the image from the camera (step 645) to form an augmented image. The augmented image is then presented to the user (step 650). The steps 610 to 650 are repeated for each image as indicated by the dashed line arrow. It should be noted that the steps 610 to 630 need not be repeated if the user does not move.

The calibration of the camera (step 600) has the object of enabling good integration of the elements, such as virtual objects, in the images from the camera, by modeling the behavior of the camera for any type of environment in which it operates, that is to say by modeling the transformation of a point in space into a point of the image. The main steps of calibrating the PTZ type camera are preferably as follows:
calibration of radial distortion;
calibration of imaging module (e.g. CCD sensor) roll;
calibration of field of view;
calibration of distance between optical center and camera rotation center; and
colocation of real scene relative to camera.

It is important to note that the focal value information provided by PTZ type cameras does not correspond to “metric” data. It is therefore necessary to construct accurately a table of correspondence between the zoom value given by the PTZ camera and the intrinsic parameters retrieved after calibration.

It is necessary first of all to outline the projective geometry used to express the relationship between a point in space and its projection onto the image plane.

The following notation is used in the remainder of the description:

O is the position of the camera, and k is the line of sight;
(O, \vec{i}, \vec{j}, \vec{k}) is the frame of reference tied to the camera, in space;
(D, \vec{u}, \vec{v}) is the frame of reference in the image;
O′ is the center of the image, the coordinates of O′ in the frame of reference (D, \vec{u}, \vec{v}) being (u₀, v₀);
Δ is the straight line segment perpendicular to the image plane and passing through the point O, Δ thus representing the optical axis of the camera;
f is the focal distance, that is to say the distance between the point O and the image plane;
M is a point in space with coordinates (x, y, z) in the frame of reference (O, \vec{i}, \vec{j}, \vec{k}); and
m is the projection of the point M in the image plane along the straight line OM, the coordinates of m in the frame of reference (O, \vec{i}, \vec{j}, \vec{k}) being (x′, y′, z′), where:

$${x}^{′} = f \frac{x}{z} ; {y}^{′} = f \frac{y}{z} ; {z}^{′} = f$$

The projection matrix Pᵣ for going from a point M to the point m can be written in the following form:

$${P}_{r} = ( \begin{matrix}1 & 0 & 0 & 0 \\ 0 & 1 & 0 & 0 \\ 0 & 0 & 1 & 0 \\ 0 & 0 & \frac{1}{f} & 0\end{matrix} )$$

and the affine transformation matrix K for going from the frame of reference (O, \vec{i}, \vec{j}, \vec{k}) to the frame of reference (D, \vec{u}, \vec{v}) can be written in the following form:

$$K = ( \begin{matrix}{k}_{u} & 0 & 0 & {u}_{0} \\ 0 & {k}_{v} & 0 & {v}_{0} \\ 0 & 0 & 0 & 1\end{matrix} )$$

where (u₀ v₀ 1) are the homogeneous coordinates of the point O in the frame of reference (D, \vec{u}, \vec{v}), expressed in pixels, kᵤ is the horizontal scaling factor, and kᵥ is the vertical scaling factor, expressed in pixels per millimeter.

The intrinsic parameters of the camera are the internal characteristics of the camera. The geometrical model of the camera is expressed by the matrix product K·Pᵣ which gives the relationship between the coordinates in the frame of reference (O, \vec{i}, \vec{j}, \vec{k}) of the point M(x, y, z) and the coordinates in the frame of reference (D, \vec{u}, \vec{v}) of the point q(u, v), projection of M into the image plane. The coordinates of the point q can therefore be expressed in the following form:

$$u = {k}_{u} f \frac{x}{z} + {u}_{0} ; v = {k}_{v} f \frac{y}{z} + {v}_{0}$$

The intrinsic parameter matrix A can be expressed in the following form:

$$A = fK \cdot {P}_{r} = ( \begin{matrix}{α}_{u} & 0 & {u}_{0} \\ 0 & {α}_{v} & {v}_{0} \\ 0 & 0 & 1\end{matrix} )$$

$$where {α}_{u} = {k}_{u} f and {α}_{v} = {k}_{v} f$$

because it is possible to multiply all the coefficients K·Pᵣ by a factor f, the homogeneous coordinates being defined apart from a factor.

The intrinsic parameters must be linked to other information more generally used in the video world such as the resolution, in pixels, the size of the image sensor, in millimeters, and the focal value according to the known relationships.

The extrinsic parameters correspond to the rigid spatial transformation of the camera. The transformation matrix D, taking into account three degrees of freedom linked to the rotation R and three degrees of freedom linked to the translation T, can be written in the following form:

$$D = ( \begin{matrix}{r}_{11} & {r}_{12} & {r}_{13} & {t}_{x} \\ {r}_{21} & {r}_{22} & {r}_{231} & {t}_{y} \\ {r}_{31} & {r}_{32} & {r}_{33} & {t}_{z} \\ 0 & 0 & 0 & I\end{matrix} ) = ( \begin{matrix}R & T \\ 0 & 1\end{matrix} )$$

It is then possible to write the matrix of any perspective projection in the form of a 3×4 matrix defined apart from a factor λ=f, f being the focal value:

$$P = A ( \begin{matrix}1 & 0 & 0 & 0 \\ 0 & 1 & 0 & 0 \\ 0 & 0 & 1 & 0\end{matrix} ) D$$

However, this is valid only for a perfect or “pin-hole” camera, that is to say a theoretical camera using no lens. The cameras generally use at least one lens that induces geometric and calorimetric distortion. Only the geometric distortion is discussed here. The geometric distortion introduced by a lens can be divided into two components, radial distortion and tangential distortion. Radial distortion is operative radially around the optical center in the image, either negatively (pincushion distortion) or positively (barrel distortion). This distortion can be modeled polynomially, with mononomials of even degree. The tangential distortion can result from off-center lenses or lens imperfections.

Considering square pixels (αᵥ/αᵢ=1), a focal distance of one pixel (αᵥ=αᵥ=1), and assuming that there is no tangential distortion (p₁=p₂=0), the distortion can be formulated in the following simplified and non-linear manner:

u′=u−u₀

v′=v−v₀

d²=u′²+v′²

ρ=1+α₁d²+α₂d⁴

U=u₀+u′ρ

V=v₀+v′ρ

where (u, v) are the coordinates (in pixels) resulting from perfect perspective projection, α₁ and α₂ are respectively the horizontal and vertical focal values (in pixels), (u₀, v₀) are the coordinates (in pixels) of the optical center projected into the image, and (U, V) are the coordinates (in pixels) after distortion.

This simplification is explained by the fact that for a PTZ camera only one distortion is calculated for a set of focal values, the distortion parameters being thereafter interpolated for the intermediate focal values. There is therefore no point in taking the latter into account in the formulation.

To obtain sufficient accuracy at the same time as limiting the volume of calculation to enable real time execution of the observation device, the solution is to consider the camera used as a simple ideal camera for which compensation is effected outside the camera model. Thus the distortion is pre-compensated and other residual errors, such as the optical center, are not compensated at the projection level but by considering that such errors come from the positioning (position and orientation) of the camera. Even though in theory this approach can be found to be false, it nevertheless achieves good results.

To summarize, all errors in the intrinsic and extrinsic parameters relative to the perfect camera model are compensated with the aid of the extrinsic parameters. For example, optical decentring involving the intrinsic parameters (u₀, v₀) is compensated in the position and orientation extrinsic parameters of the camera.

Moreover, this compensation must not be considered constant as it can be a function of the variation of the aiming command parameters of the user. Thus most compensations are calibrated for a set of focal values and interpolated when the focal value is between two focal values for which the compensations to be applied have been calculated.

This approach correctly superposes the virtual objects on the images of a real scene, displaying the compensated images of the real scene and rendering the virtual objects with a virtual camera that is simply offset and compensated in position and in orientation. The real time calculation cost of the virtual PTZ camera model is then almost the same as that for a perfect virtual camera (pinhole camera).

The approach to calibrating a PTZ type camera is different than that used for a standard camera, however. It is necessary to calibrate radial distortion and the field of view for a number of zoom values. The corresponding parameters are then associated with a precise level of zoom given in real time by the camera. Thereafter, during use of the observation device, these parameters are interpolated as a function of the current level of zoom of the camera.

Each calibration phase uses the compensations from previous calibration phases. Accordingly, to be able to consider the camera as a pinhole model, it is necessary to begin by compensating the distortion. When the radial distortion has been corrected, it is then possible to calibrate image sensor roll, which has the effect of rotating the image around the center of the distortion. To this end, it is necessary to determine if, during a pan (horizontal rotation) the trajectory of the points in the image is indeed a horizontal trajectory and, if necessary, to compensate this defect. When this compensation is established it is possible to measure the horizontal field of view simply by effecting a pan. The focal value of the camera is thus calibrated and a sufficiently comprehensive camera model is then available to compare the projection of a point theoretically on the optical axis and its real position as a zoom is effected.

After compensation of this decentring, it is finally possible to compensate the distance between the optical center and the rotation center of the camera.

The above formulation of the distortion shows that it is necessary to know the position of the optical center in order to estimate the distortion. Calibration uses a test pattern consisting of a set of coplanar points placed in a regular and known manner. To measure and estimate the distortion, one solution is to compare the theoretical projection of all the points with the actual projection observed, which implies knowing extrinsic position and orientation parameters of the test pattern relative to the camera and the horizontal and vertical focal value intrinsic parameters.

To be able to calibrate the distortion, it is thus in theory necessary to know all the parameters of the camera (intrinsic and extrinsic) or to adopt very precise conditions as to the placement of the test pattern relative to the camera. This latter approach being difficult to achieve, it is then in theory necessary to calibrate all the parameters of the camera simultaneously. The method used calibrates simultaneously all the parameters of the camera but retains only those linked to distortion, the others being estimated afterwards by another method.

The distortion is estimated for a number of focal values of the camera. Moreover, apart from the mechanics of the PTZ camera, the distortion does not depend on the orientation of the camera, which is preferably left centrally oriented during the distortion calibration step.

The first phase of the calibration, for a given focal value expressed not as a metric focal value but as a value from the encoder of the camera, plus the zoom factor, places a test pattern in front of the lens of the camera and analyzes the projection of the points of the test pattern in the image.

The points of the test pattern form a set of coplanar points placed regularly (fixed and known horizontal and vertical spacing). The test pattern is characterized by determining one of its points as a reference. This reference point defines the frame of reference of the test pattern relative to which all the other points of the test pattern can be expressed.

The expression for the configuration of the test pattern relative to the camera therefore amounts to expressing the configuration (position and orientation) of that point relative to the optical center of the camera. This configuration can be modeled by the data for a position T=(Tₓ, T_{y}, T_{z}) that represents the position of the optical center relative to the origin of the test pattern expressed in the frame of reference of the test pattern, together with three Euler angles (γ, β, α) representing the respective rotations about X, Y, Z applied successively in that order. Any point N of the test pattern can thus be expressed in the local frame of reference M of the test pattern by the following equation:

P_{N/M}=(X_{N}, Y_{N}, 0)

Likewise, any point N in the test pattern can be expressed in the frame of reference C of the camera by the following equation:

P_{N/C}=Rot·(P_{N/M}−T)

where:

$$Rot = {Rot}_{z} \cdot {Rot}_{y} \cdot {Rot}_{x} = ( \begin{matrix}ca \cdot cb & ca \cdot sb \cdot sg - cg \cdot sa & ca \cdot cg \cdot sb + sa \cdot sg \\ cb \cdot sa & ca \cdot cg + sa \cdot sb \cdot sg & cg \cdot sa \cdot sb - ca \cdot sg \\ - sb & cb \cdot sg & cb \cdot cg\end{matrix} )$$

where:

$${Rot}_{x} = ( \begin{matrix}1 & 0 & 0 \\ 0 & cg & - sg \\ 0 & sg & cg\end{matrix} ) , {Rot}_{y} = ( \begin{matrix}cb & 0 & sb \\ 0 & 1 & 0 \\ - sb & 0 & cb\end{matrix} )$$

$$and {Rot}_{z} = ( \begin{matrix}ca & - sa 0 & 0 \\ sa & ca & 0 \\ 0 & 0 & 1\end{matrix} )$$

$$where$$

$$ca = cos α$$

$$sa = sin α , \\ cb = cos β$$

$$sb = sin β and$$

$$cg = cos γ$$

$$sg = sin γ$$

α being the angle of rotation about the x axis, β being the angle of rotation about the y axis, and γ being the angle of rotation about the z axis.

From the mathematical model, the image coordinates (u, v) of this point of the test pattern projected onto the image plane of the camera generate an error (squared) Eₙ relative to the measurement (uₙ, vₙ).

The calibration steps are therefore as follows:
choose a test pattern;
determine the position of the points of the test pattern in the observed image;
choose a reference point P_{O/M} from these points of the image. This point P_{O/M} therefore has (0, 0, 0) as coordinates in the frame of reference of the test pattern. All the other points have a position in the frame of reference of the test pattern that can be written in the form P_{N/M}=(X_{N}, Y_{N,0})=(δ_{w}.i, δₕ.j,0) where δ_{w} and δₕ are respectively the horizontal and vertical metric distance between two consecutive points in the test pattern;
chose approximate intrinsic parameters (horizontal focal value, vertical focal value, radial distortion, optical center) and extrinsic parameters (position and orientation) for the camera. This choice represents the initialization of an iterative algorithm that thereafter estimates these parameters; and

apply the conjugate gradient technique by calculating the secant on the function representing the error between the model and the measurements according to the equation

$$fct = {\sum }_{i} {E}_{i} .$$

On completion of the convergence of the algorithm of the conjugate gradient, all the parameters of the camera have been estimated simultaneously. However, because of the poor numerical stability of some parameters, such as the focal value, it is preferable to retain only the two distortion parameters (a₁, a₂) that are associated with the value from the encoder of the zoom factor of the camera. This results in a map of the radial distortion as a function of the values from the encoder of the zoom factor. According to the formulation used, this distortion has its center at the center of the image and not at the optical center. However, the camera being considered perfect, the optical center is therefore at the center of the image. The error that occurs if the two centers are different is corrected beforehand by a rotation.

In practice, it is preferable to start with the lowest zoom factor and to place the test pattern in front of the camera, perpendicularly to the optical axis, so that a maximum of points is visible in the image without leaving a border. It is then necessary to fix the image and to determine the position of the points of the test pattern in the image by image analysis. When the points are paired, a fitting calculation (conjugate gradient calculation) is started and the result is saved. The zoom factor is then increased and the previous steps are repeated. As the zoom factor increases, it is necessary to move the test pattern away from the camera.

This phase of calibration of the distortion can be automated. According to a first approach, the test pattern, computer-controllable, is placed on a mechanical rail so that the test pattern can be moved away from the camera. According to a second approach, using the fact that the distortion is considered independent of the orientation of the camera, a set of test patterns is placed in front of the camera, each is placed at an angle and a distance ensuring that for each zoom factor chosen for the calibration there exists a pan configuration for observing one test pattern and only one test pattern at the correct distance.

After calibrating the distortion, it may be necessary to calibrate the roll of the image sensor. It is possible that the sensor of the camera, for example a CCD sensor, is not perfectly oriented relative to the mechanics that move the camera. It should be noted that the distortion being radial, compensation of distortion cannot compensate a roll defect of the image sensor. To compensate the roll defect, it is necessary to turn the virtual camera virtually about its optical axis by an angle θ that has to be estimated. This angle is considered independent of the zoom factor.

To estimate the angle θ, it is necessary to determine a reference point situated in the observed scene, substantially at the center of the image from the camera, and to pan the camera. If the angle is zero, the reference point must remain continuously on the mid-height line, or horizon line, of the image from the camera; if not, it passes below or above this mid-height line. The angle θ is then estimated for the reference point to have a perfectly horizontal movement in the image. This step need be effected only for one zoom value, for example the lowest zoom value.

In practice, this step can be automated by tracking a decor point while panning the camera and calculating the compensation to be effected for the movement to be horizontal in the image. For greater robustness, this calculation can be effected over a set of points, the angle θ being evaluated according to an average.

As described above, the zoom factor is controlled by indicating a value given to the encoder in charge of zooming to calibrate the distortion. The focal value is therefore not directly available. To calibrate the field of view, the principle is to create a map between the zoom encoder values and the field of view angle θᵤ. Using the field of view determines the focal value in pixels according to the following equation:

$${α}_{u} = \frac{FoW}{2 \cdot tan ( \frac{{θ}_{u}}{2} )}$$

where FoW is the width of the field of view corresponding to the (known) horizontal resolution in pixels.

To establish the map of the zoom encoder values as a function of the field of view angle θᵤ, one solution is to aim at a point or a vertical line of the decor situated at the center of the image when the pan angle is at zero, and to change the pan angle until that point or that line is precisely at the right-hand or left-hand edge of the image. This measures the half-angle of the horizontal field of view so that the horizontal focal value can be calculated. The horizontal focal value enables the vertical focal value to be deduced from the known focal value ratio, and this solution is applicable if the relation between the pan encoder and the pan angle is linear, known and symmetrical with respect to the pan center.

This procedure could be automated by tracking a point or a line of decor while panning, until the tracked element disappears. The pan encoder then gives the half-value of the horizontal field of view directly. If the optical center is not exactly at the center of the image, the off-centeredness can be corrected by a rotation combining pan and tilt to avoid inserting that offcenteredness into the intrinsic parameters.

As mentioned above, the choice has been made here to consider the camera as perfect. Accordingly, the pan and tilt errors relative to the optical axis of the camera are compensated not by making the model of the camera more complex but by using an offset for the position and the orientation of the camera. This pan and tilt offset is preferably measured for all zoom factors. The measurement is effected, for example, by aiming at a point of the decor located relatively far off using the smallest minimum zoom factor. For each increase of the zoom factor, the pan and tilt offset is adjusted manually on the virtual camera so that the virtual point associated with the point aimed at remains superposed on the latter. This procedure can naturally be automated by tracking a point of the decor during a zoom movement and compensating the error in pixels by a pan and tilt offset.

The calibration of the offset between the optical center and the rotation center of the camera is the final phase of the calibration step. This calibration of the offset between the optical center and the rotation center of the camera is not necessary if the filmed scene and the position of the virtual objects in the filmed scene are always far away from the camera. In the other calibration steps, it was considered that the optical center and the center of physical rotation of the camera were at the same point. This might be incorrect but has virtually no impact if the visual elements are a few tens of centimeters away. However, for near points, the previous compensations are not sufficient and it can be necessary to take into account this offset of the optical center. It is considered here that the offset exists only along the optical axis, which is consistent with the fact that the previous calibrations have the object of compensating the offset, except on its optical axis component.

To determine the offset between the optical center and the rotation center of the camera, one solution is to aim at a point of the decor situated physically close to the camera and the physical distance from the camera of which has been measured beforehand. This point is preferably chosen in the middle of the image if the line of sight of the camera is oriented with a zero pan angle and a zero tilt angle. For each increase in the zoom factor, the pan angle of the camera is modified until the point aimed at is at the edge of the image. The offset is then adjusted manually so that the virtual point associated with the real point is superposed on the latter. It is possible to automate the calibration of the offset between the optical center and the rotation center of the camera by automatically tracking a near point of the decor by varying the zoom factor and compensating the error in pixels by an offset in translation along the optical axis.

If calibration of the camera is necessary to obtain good integration of the virtual objects in the images from the camera, it is also necessary to know accurately the position and the orientation of the object relative to the camera or, what amounts to the same thing, to know the configuration of the real camera relative to the real world it films. This calculation is called a “pose” calculation. To effect the pose calculation, an object from the three-dimensional scene must be put into relation with its two-dimensional image. For this, it is necessary to have coordinates of a number of points of the object in the real scene (three-dimensional coordinates), all expressed relative to a point of the object considered as an object reference during the pose calculation. Also required, for this set of points, are the coordinates of their projection in the image (two-dimensional coordinates). The pose is then evaluated at a number of levels.

A first level effects a fast calculation to obtain an approximate pose while a second level, using a longer calculation, uses the approximate pose to improve the pose estimate, iteratively.

The first level estimation is based on a first order approximation of the perspective projection model with a weak perspective. This method is fast and robust if the points chosen in the real space are distributed over all of the surface of the object and are not coplanar. Moreover, for convergence, it is necessary for the object to be visible somewhat at the center of the image and situated relatively far from the camera. This method, known in the art, is described, for example, in the paper “Model-Based Object Pose in 25 Lines of Code”, D. DeMenthon and L. S. Davis, International Journal of Computer Vision, 15, pp. 123-141, June 1995, and in the paper “Object Pose: The Link between Weak Perspective, Paraperspective, and Full Perspective”, R. Horaud, F. Dornaika, B. Lamiroy, S. Christy, International Journal of Computer Vision, volume 22, No. 2, 1997.

This method effects a pose calculation by choosing one of the points of the object, in the three-dimensional space, as a reference. It has been noted, however, that the quality of the estimate of the pose varies as a function of the reference point chosen and it is sometimes useful to eliminate some points to obtain a better result, whilst retaining at least five non-coplanar points. It is thus advantageous, if the object comprises r points in the three-dimensional space, to effect r.(r−5) pose calculations each time taking one of the r points as the reference point and then eliminating in each iteration, among the other points, the point that is farthest from the reference point. For each of these pose calculations, an average of the reprojection error into the image plane is calculated. The final pose is that which corresponds to the smallest error.

The second level estimation uses a stochastic exploration, guided by an error criterion, of the configuration space, that is to say the six-dimensional space corresponding to all of the (position, orientation) pairs close to the current pose. The idea is to start from the current pose and then move a random short offset in the configuration space. If the new configuration conforms better to the error criterion, then it becomes the new reference; if not, another random offset is used. The steps of this method are therefore as follows:
select the pose determined according to the first level estimate;
create s random offsets of the current pose configuration;
for each of these random offsets, calculate the error generated by that pose; if the error is smaller than that obtained until now, then this pose is considered better and stored;
if at the end of estimating these s random offsets none has improved the current pose error, then a failure counter is incremented; if not, the failure counter is reset to zero and the new current configuration is that stored; and
if the failure counter reaches a predetermined threshold, the process is stopped; if not, the preceding three steps are repeated.

The error is preferably calculated by summation, for each point, of the squared orthogonal distance between the point (P) of the object, in the three-dimensional space, in the pose (P) considered and the straight line segment, in the three-dimensional space resulting from the projection into the two-dimensional image associated with the point, in the three-dimensional space, and the projection center of the camera (defined by the center of the camera in the three-dimensional space and a unit vector u the direction of which is defined by the center of the camera and the point concerned in the three dimensional space).

When the camera has been calibrated and its configuration (position/orientation) relative to the environment is known, it is possible to insert virtual objects or any other element such as a secondary video stream into the images from the camera. The virtual objects can be inserted into the video stream in real time by the D'Fusion software from the company Total Immersion as indicated above.

The choice of the virtual object to be inserted into the video stream can be effected by geo-location and constituting a database. This database can be constituted manually or from existing databases via a connection to a network such as the Internet, for example.

Alternatively, the camera of the observation device can be remotely sited as shown in FIG. 7. In this embodiment, one or more cameras are installed at locations that are not directly accessible to users, such as the top of a building, in a cave or under water. However, these cameras are connected to the user command interfaces so that they control the movements from a control and viewing platform. The use of cameras and where appropriate computers that are remotely located means that the cameras can also be placed at inaccessible locations to protect the equipment from vandalism or theft.

FIG. 7 shows an observation device 300′ including a sphere 305′ to which are movably fixed a command interface 310′ and a viewing system 320″. The sphere 305′ is preferably coupled to a stand 400′ mounted on a base 405′ containing a computer 500′ that can also be remotely sited. A footplate 410′ enables users to position themselves appropriately in front of the command interface 310′ and the viewing system 320″. Here the camera 335″ is remotely sited by fixing it to a chimney 700 of a house 705.

Of course, to meet specific requirements, a person skilled in the field of the invention can apply modifications to the above description, notably where the aiming movement control means and the observation device are concerned.

1. A method for a real time augmented reality observation device (300) comprising an image sensor (335), a viewing system (320) and an indirect command interface (310) with direct line of sight, said method comprising the following steps:
receiving a request including line of sight orientation information transmitted by said command interface (610);
transmitting said line of sight orientation information to said image sensor (615), said image sensor being mobile and motorized;
receiving from said image sensor the orientation of its line of sight (620);
receiving at least one image from said image sensor;
determining in said received image the position at which at least one item of data must be inserted, according to the orientation of the line of sight of said image sensor (640); and
inserting said at least one data item in real time into said received image at the position so determined (645).

2. Method according to claim 1, wherein said viewing system is mobile and mechanically connected to at least one element of said command interface.

3. Method according to claim 1, further comprising a phase of calibrating said image sensor (600).

4. Method according to claim 3, wherein said calibration step comprises the calibration of at least one of the parameters included in the set of parameters comprising correcting radial distortion of said image sensor, correcting roll of said image sensor, correcting the pan and tilt of the line of sight of said image sensor and the offset between the optical center and the rotation center of said image sensor.

5. Method according to claim 4, wherein said image sensor comprises a zoom function and the calibration of said at least one parameter is effected for a plurality of zoom factors.

6. Method according to claim 1, further comprising a step of colocation of said image sensor and the scene observed by said image sensor to determine the pose of said at least one data item to be inserted into said image received in said observed scene.

7. Method according to claim 1, wherein at least one data item to be inserted in said received image is dependent on the geographical position of said observation device.

8. Method according to claim 1, wherein that said at least one item of data to be inserted in said received image is a representation of a three-dimensional virtual model animated or not.

9. Method according to claim 1, wherein said orientation of the line of sight is defined with respect to two degrees of freedom and said image sensor comprises a zoom function.

10. Computer program stored on a computer readable storage medium, and including instructions adapted to execute each of the steps of the method according to claim 1.

11. An augmented reality observation device (300) comprising:
means for connection to an image sensor (335), a viewing system (320) and an indirect command interface (310) with direct line of sight:
means for receiving line of sight orientation information transmitted by said command interface;
means for controlling the orientation of the line of sight of said image sensor according to said orientation information received, said image sensor being mobile and motorized;
means for receiving the orientation of the line of sight of said image sensor;
means for receiving at least one image from said image sensor;
means for determining in said received image the position at which at least one item of data must be inserted, according to the orientation of the line of sight of said image sensor; and
means for inserting in real time into said received image said at least one data item at said position so determined.

12. Device according to claim 11, wherein said viewing system is mobile and mechanically connected to at least part of said command interface.

13. Device according to claim 11, further comprising means for transmitting said received image comprising said at least one item of data.

14. Device according to claim 1, wherein said image sensor and/or said storage means is remote from said observation device.

15. Method according to claim 2, further comprising a phase of calibrating said image sensor (600).

16. Device according to claim 12, further comprising means for transmitting said received image comprising said at least one item of data.
